(19) United States
(12) Patent Application Publication
(10) Pub. No.: US 2003/0235644 A1
(43) Pub. Date: Dec. 25, 2003

(54) Method for manufacturing green elemental bean sprouts using yellow light

(76) Inventors: Jac-Seung Roh, Icheon-Shi (KR); Ill-Min Chung, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/403,800

(22) Filed: Mar. 28, 2003

Related U.S. Application Data
(63) Continuation of application No. PCT/KR00/01091, filed on Sep. 29, 2000.

(30) Foreign Application Priority Data
Apr. 18, 2002 (WO) 02/030177 A1

(51) Int. Cl. A23L 2/38

(52) U.S. Cl. 426/598

(57) ABSTRACT

Disclosed is a method for manufacturing green bean sprouts using yellow light, a process for preparing nutritional drink using the green bean sprouts and a nutritional drink prepared thereby. The method for manufacturing green bean sprouts of the invention has steps of: germinating wettedbeans under the lightening condition of yellow light; and, cultivating the germinated beans. The green bean sprouts manufactured by using yellow light contains nutritional elements and isoflavone at a similar level of those of the green bean sprouts manufactured by using several kinds of monochrome lights in a sequential manner, which makes possible the economical manufacturing of green bean sprouts. Moreover, the nutritional drink may be practically utilized for the uptake of isoflavone which is effective for the treatment of cancer and osteoporosis, and the control of cholesterol and glucose level in blood.

### BACKGROUND OF THE INVENTION

1. Field of the Invention

The present invention relates to a method for manufacturing green bean sprouts, more specifically, to a method for manufacturing green nutritional bean sprouts under a condition of yellow light, a process for preparing nutritional drinks using the green bean sprout manufactured by the said method and nutritional drinks prepared by the said process.

2. Background of the Invention

Bean sprout is a Korean native food consumed in Asian countries including Japan and China, and recently in U.S.A. and some of European countries. Although bean sprout is one of the most popular vegetable and its consumption is being spread worldwide, the reason why the bean sprouts are so cheap and their nutritional value is not appreciated is that the bean sprouts are cultivated under a condition lacking light, resulting in yellow-colored bean sprouts of which nutritional value is low.

In general, bean sprouts are cultivated by putting beans(for bean sprout) in a well draining container with supply of water 6 to 8 times a day in a dark room to keep cotyledon and hypocotyl of fully grown bean sprout tender, resulting in white stem and yellow head. Thus, nutritive substances exist in the bean per se are almost used up in growing stem, meanwhile, additional nutrients are not able to be produced by photosynthesis, making bean sprout innutritious food even though it is coming from the bean which is commonly called as vegetable meat.

Isoflavones, the most important components of the bean, are known to be contained abundantly in soybean paste, a fermented soybean product, and tofu, and recently are reported to be effective on the prevention of tumor related diseases such as cancers of lung, colon, stomach, liver, pancreas, mouth, skin, esophagus, breast and prostate, and leukemia, and to have an anticancer activity which inhibits the growth of tumors selectively, additionally, effective on osteoporosis, hypertension and diabetes. However, conventional bean sprouts contain little amount of isoflavone, and less amount of various nutritive elements than the beans except asparagine which is known to be effective on relief of hangover.

To solve the problems mentioned above, the present inventors developed a method for cultivating green nutritional bean sprouts containing abundant nutritive elements, still keeping cotyledon and hypocotyl tender(see: Korean Patent Publication No. 99-78858). In accordance with the method for cultivating green bean sprouts, palatable green nutritional bean sprouts with tender cotyledon and hypocotyl are produced by cultivating the bean sprouts under various monochromatic lights in a sequential manner, not in a dark room, letting photosynthesis undergo to synthesize various nutritive substances, especially, over 2-fold increase in isoflavone content compare to that of original bean. However, the said method employing illumination of a series of monochromatic lights, requires large-scale facilities of cultivating rooms for red light illumination, green light illumination, and yellow light illumination, and conveyer belts for transportation between the rooms, which increase the production cost.

Under the circumstances, there are strong reasons for exploring and developing a method for manufacturing palatable green nutritional bean sprout containing abundant nutritive substances with tender cotyledon and hypocotyl in a simple and economical way.

### SUMMARY OF THE INVENTION

The present inventors have made an effort to develop a method for manufacturing palatable green nutritious bean sprout containing abundant nutitive substances with tender cotyledon and hypocotyl in a simple and economical way, and have found that the green nutritious bean sprouts which have similar quality to those grown under a series of monochromatic lights by the prior art method, can be produced by employing solely yellow light, and nutritional drinks can be prepared using the said green bean sprouts.

A primary object of present invention is, therefore, to provide a method for manufacturing green bean sprouts using yellow light.

The other object of the invention is to provide a process for preparing nutritional drinks using the said green bean sprouts.

Another object of the invention is to provide nutritional drinks prepared by the said process.

### DETAILED DESCRIPTION OF THE INVENTION

The method for manufacturing green bean sprouts of the invention comprises the steps of: germinating beans soaked in water; and, cultivating the germinated beans under a condition of yellow light.

The principle of the invention is as follows: when the white light is illuminated onto a yellow filter, most of two monochromatic lights, i.e., green light which stimulates photomorphogenesis of bean sprout and red light which is used for synthesis of chlorophyl and photosynthesis, pass through the filter, meanwhile the other wavelength lights are shut off, which not only reduce cultivation time and maximize the content of nutritive elements but also produce tender stems. Herein, the wavelength of yellow light is preferably 550 to 600 nm, and bean sprouts are preferably cultivated in a dark room equipped with light bulbs illuminating yellow light, or green house built with a yellow acrylic film(absorbancy: R=0.043±0.001, G=0.373±0.002, B=2.613±0.037) or yellow film-coated plastic film for green house, but without limitation, any equipments or facilities which can illuminate the light of said wavelength may be used. Temperature in the cultivating room is maintained at preferably 25 to 30° C., most preferably, 27° C., soaking time of dry beans is preferably 3.5 to 4.5 hours. The swelled beans are placed in a cultivating container and germinated for preferably 18 to 22 hours, most preferably 20 hours with sporadic water spray not to dry out, and then cultivated for preferably 3 to 5 days, most preferably 4 days by sprinkling or spraying water with an interval of 2 to 3 hours to produce green bean sprouts.

When the green bean sprouts manufactured by the invented method were compared with those produced by the prior method disclosed in Korean Patent Publicaton No. 99-78858 and those produced under individual monochromatic lights other than yellow light, the content of nutritiritive elements of the green bean sprouts of the invention is superior to that of bean sprouts produced by using monochromatic lights or the prior method, as well as the texture of the green bean sprout of the invention was maintained tender as conventional bean sprouts, thereby solving the stiffening and toughening problem of bean sprouts grown under light.

Nutritional drinks can be prepared using the green bean sprouts manufactured by the said method, wherein cotyledon and hypocotyl may be separated and used respectively as raw materials for nutritional drinks, or whole green bean sprouts may be used. The process for preparing the nutritional drinks comprises the steps of: heat treatment of the green bean sprouts in 0.05 to 0.15% NaCl solution at 90 to 100° C. for 2 to 3 minutes to remove beany smell, cooling down, pulverizing a mixture of the cooled bean sprouts and water(1:4, w/w); and, filtration and sterilization of the mixture. To enhance palatability, sweeteners such as glucose, sucrose, fructose, and sugar may be added therein. With high level of isoflavones, the nutritional drink prepared in this way may be utilized as a beneficial drink for preventing cancer, furthermore, the nutitional drink prepared using hypocotyl contains much higher amount of asparagine compare to the commercially available conventional nutritional drinks, again, it is expected that the nutritional drink of the invention may be beneficially utilized.

The present invention is further illustrated in the following examples, which should not be taken to limit the scope of the invention.

### EXAMPLE 1

### Manufacture of Green Bean Sprouts

First, cultivating room was built using a yellow acrylic film-coated plastic film for green house, in which light bulbs illuminating yellow light were equipped to illuminate the room on cloudy days and at nights, the room temperature was maintained at 27° C., and all manipulations were performed in the cultivating room. 200g of dry beans (for bean sprout) were soaked in 2L of water for 4 hours and placed in cultivating containers after water was drained. During 20 hour germination period, the beans were kept wet by spraying water onto the beans. Then, the germinated beans were grown for 4 days with supply of water every 3 hours to yield 1 kg of green bean sprouts.

### COMPARATIVE EXAMPLE 1

### Manufacture of Bean Sprouts Without Using Light

800 and 50g of yellow-colored bean sprouts were manufactured in a similar manner as in Example 1 except that the cultivation was carried out in a dark room.

### COMPARATIVE EXAMPLE 2

### Manufacture of Green Bean Sprouts Using White Light

500 and 20g of green bean sprouts were manufactured in a similar manner as in Example 1 except for employing white light instead of yellow light: Lengthening of cultivation time yielded higher productivity, while it also increased fiber content of bean sprouts which lowered the quality, caused infection and rotting, and lowered content of nutritive substances.

### COMPARATIVE EXAMPLE 3

### Manufacture of Green Bean Sprouts Using Monochromatic Red Light

800g of green bean sprouts were manufactured in a similar manner as in Example 1 except for employing monochromatic red light instead of yellow light.

### COMPARATIVE EXAMPLE 4

### Manufacture of Green Bean Sprouts Using Monochromatic Green Light

900 and 50g of green bean sprouts were manufactured in a similar manner as in Example 1 except for employing monochromatic green light instead of yellow light.

### COMPARATIVE EXAMPLE 5

### Manufacture of Green Bean Sprouts Using Monochromatic Red Light, Green Light, and Red Light in a Sequential Manner

Green bean sprouts were produced by the prior method disclosed in Korean Patent Publication No. 99-78858. 200g of dry beans(for bean sprout) were soaked in 2L of water for 4 hours, germinated for 20 hours in the cultivating room equipped with red light. After transferring to the cultivating room equipped with green light, the germinated beans were grown for 2 days with supply of water every 3 hours to obtain 980g of green bean sprouts.

### EXAMPLE 2

### Comparison of Nutritional Contents of the Bean Sprouts

Protein, lipid, ash(mineral), Vitamin B1, Vitamin B2, asparagine, isoflavone, fiber and calorie contained in the bean sprouts manufactured in Example 1, Comparative Examples 1 to 5 were measured by the conventional method and compared in Table 1.

TABLE 1
Nutritional contents of the bean sprouts

| | | Comparative | Comparative | Comparative | Comparative | Comparative |
|---|---|---|---|---|---|---|
| | Example | Example | Example | Example | Example | Example |
| Item | 1 | 1 | 2 | 3 | 4 | 5 |
| Protein | 7.61 | 3.65 | 7.65 | 7.52 | 7.58 | 7.63 |
| (%) | | | | | | |
| Lipid (%) | 1.21 | 1.13 | 1.22 | 1.17 | 1.19 | 1.22 |
| Ash (%) | 0.79 | 0.71 | 0.81 | 0.76 | 0.77 | 0.80 |
| Vit B₁* | 3.41 | 0.09 | 3.38 | 3.35 | 3.38 | 3.40 |
| (mg/g) | | | | | | |
| Vit B₂* | 2.88 | 0.10 | 2.98 | 2.85 | 2.86 | 2.90 |
| (mg/g) | | | | | | |
| Vit C* | 15.7 | 0.70 | 15.98 | 15.60 | 15.62 | 15.58 |
| (mg/g) | | | | | | |
| Asparagine | 1.70 | 0.32 | 1.58 | 1.68 | 1.71 | 1.69 |
| *(mg/g) | | | | | | |
| Isoflavone | 2.36 | 0.04 | 2.20 | 2.17 | 2.17 | 2.25 |
| *(mg/g) | | | | | | |
| Fiber* | 0.83 | 0.60 | 0.81 | 0.80 | 0.82 | 0.82 |
| (mg/g) | | | | | | |
| Calorie* | 55.40 | 33.25 | 55.46 | 55.38 | 55.42 | 55.38 |
| (cal/100 g) | | | | | | |
| Yield per | 1,000 | 850 | 520 | 800 | 950 | 980 |
| 200 g of | | | | | | |
| beans | | | | | | |

*dry weight

As shown in Table 1 above, in terms of nutritional contents, all items of the green bean sprouts of the invention are superior to those of the yellow bean sprouts cultivated without light, superior or similar to those of the bean sprouts cultivated using other monochromatic lights than yellow light, and similar to those of green bean sprouts cultivated by the prior method of Korean Patent Publication No. 99-78858.

### EXAMPLE 3

### Comparison of Isoflavone Contents in Green Bean Sprouts

Since the isoflavone contents of the green bean sprouts of the invention has shown to be higher than any other bean sprouts tested in Example 2 above, the contents of isoflavones, i.e., daidzin, daidzein, glycitin, genistin, genistein, of the bean sprouts manufactured in Example 1, Comparative Examples 1 to 5 were measured respectively by the conventional method, whose results are summarized in Table 2 below.

TABLE 2
Contents of isoflavones in green bean sprouts
(mg/g, dry weight)

| | | Comparative | Comparative | Comparative | Comparative |
|---|---|---|---|---|---|
| Contents | Example 1 | Example 2 | Example 3 | Example 4 | Example 5 |
| Daidzin | 0.42 | 0.27 | 0.31 | 0.26 | 0.32 |
| Daidzein | 0.00 | 0.00 | 0.00 | 0.00 | 0.00 |
| Glycitin | 0.82 | 0.87 | 0.80 | 0.87 | 0.84 |
| Genistin | 0.30 | 0.26 | 0.28 | 0.24 | 0.27 |
| Genistein | 0.82 | 0.87 | 0.78 | 0.80 | 0.82 |
| Total | 2.36 | 2.27 | 2.17 | 2.17 | 2.25 |

As shown in Table 2 above, daidzein, one of isoflavones, was not detected at all. However, the content of daidzein can be regarded as the content of daidzin, since aglycon daidzin is formed through the hydrolysis of glycosidic daidzein in the process of digestion. Meanwhile, the content of genistein, currently being studied as an anticancer agent, was the highest in the green bean sprout grown under white light, but it was too tough and stiff to be edible, yield was low and cultivation time was too long(more than two times), consequently, considering the comprehensive content of isoflavones, palatability, and cost efficiency, the green bean sprouts grown under yellow light have been found to be the best choice for isoflavone intake.

### EXAMPLE 4

### Preparation of Nutritional Drinks Using the Green Bean Sprouts

As shown in Examples 2 and 3, the green bean sprouts of the invention contain good nutrititive substances with a high level, and are an economical source of isoflavones which appear to have effective anticancer activity, thus, the inventors prepared a nutritional drink containing the said substances.

500g of green bean sprouts manufactured by the method described in Example 1 were added into 0.1%(w/w) NaCl solution, heat treated for 2 to 3 minutes at 100° C., cooled down, and then cotyledone and hypocotyl were separated. One part of cotyledone portion was mixed with 4 parts(by weight) of water, pulverized, and then heat treated for 5 minutes at 100° C. to sterilize after adding sugar to a final concentration of 0.2%(w/w), which was followed by cooling down and packaging to prepare a nutritional drink named ‘Isomeal’. Also, using whole green bean sprouts without separating hypocotyl from cotyledone, ‘Isopameal’ was prepared by the same method employed in Isomeal preparation.

### EXAMPLE 5

### Comparison of the Nutritional Contents of the Nutritious Drinks

In accordance with the conventional method, the contents of protein, lipid, carbohydrate, calorie, vitamin C, isoflavones, asparagine, fiber, calcium, potassium, phosphorous, magnesium, manganese, and iron contained in Isomeal and Aspameal prepared in Example 4 were measured, whose results are summarized in Table 3 below.

TABLE 3
Comparison of the nutritional contents of the nutritious drinks

| Ingredient | Isomeal | Aspameal |
|---|---|---|
| Protein (%) | 4.16 | 3.78 |
| Lipid (%) | 0.95 | 1.04 |
| Carbohydrate (%) | 4.37 | 3.67 |
| Calorie (cal/100 ml) | 34.87 | 33.44 |
| Vitamin C (mg/100 ml) | 1.73 | 0.36 |
| Isoflavone | 5.25 | 4.89 |
| (mg/g, dry weight) | | |
| Asparagine (mg/100 ml) | 0.93 | 517.40 |
| Fiber (mg/100 ml) | 1.95 | 1.43 |
| Calcium (mg/100 ml) | 23.56 | 7.46 |
| Potassium (mg/100 ml) | 140.40 | 59.44 |
| Phosphorous (mg/100 ml) | 66.44 | 13.84 |
| Magnesium (mg/100 ml) | 15.67 | 4.53 |
| Manganese (mg/100 ml) | 0.32 | 0.15 |
| Iron (mg/100 ml) | 0.42 | 0.22 |

As shown in Table 3 above, both Isomeal and Aspameal have been found to contain high level of isoflavones. Since Aspameal contain remarkable amount of asparagine, although the level of comprehensive contents of nutritive substances is higher in Isomeal than in Aspameal, Aspameal may be used as a nutritional drink which supplies isoflavones and asparagine simultaneously.

As clearly illustrated and demonstrated above, the present invention provides a method for manufacturing green bean sprouts under a condition of yellow light and a process for preparing nutritional drinks using the green bean sprouts manufactured by the said method. In accordance with the invention, the green bean sprouts manufactured under a condition of yellow light contain nutritive substances and isoflavones at a similar level to those produced under a series of monochromatic lights, which makes possible the economical production of the green bean sprouts. Moreover, the nutritional drink prepared using the green bean sprouts may be used as an excellent source for the uptake of isoflavones which are effective for the treatment of cancer and osteoporosis, and the control of cholesterol and glucose level in blood.

Although the preferred embodiments of the present invention have been disclosed for illustrative purpose, those who are skilled in the art will appreciate that various modifications, additions and substitutions are possible, without departing from the scope and spirit of the invention as described in the accompanying claims.

What is claimed is:

1. A method of growing bean sprouts, the method comprising:
providing a cultivating container having a drain;
providing beans to grow bean sprouts from;
placing the beans in the cultivating container;
sporadically watering beans in the container; and
illuminating the beans with yellow light, thereby growing the bean sprouts.

2. The method of claim 1, wherein prior to the placing the beans in the container, the beans are soaked in water for 1-7 hours.

3. The method of claim 2, wherein the beans are soaked in water for about 2 to about 6 hours.

4. The method of claim 2, wherein the beans are soaked in water for about 3.5 to about 4.5 hours.

5. The method of claim 1, wherein the temperature within the container containing the beans is maintained from about 20° C. to about 35° C.

6. The method of claim 5, wherein the temperature is maintained from about 25° C. to about 30° C.

7. The method of claim 1, wherein the yellow light has a wavelength of from about 550 nm to 600 nm.

8. The method of claim 1, wherein the beans in the container are watered at an interval between about 2 and about 3 hours.

9. The method of claim 1, wherein the beans are maintained in the container for about 2 to about 7 days.

10. The method of claim 1, wherein the beans are maintained in the container for about 3 to about 5 days.

11. Bean sprouts produced by the method of claim 1.

12. A method of producing a nutritional drink, comprising:
providing the bean sprouts produced by the method of claim 1;
pulverizing the bean sprouts in water; and
filtering the pulverized mixture to collect liquid.

13. The method of claim 12, wherein the weight ratio of the bean sprouts to water is about 1:4.

14. The method of claim 12, wherein the bean sprouts subject to the pulverization are in the form of whole sprouts, cytyledon part of the sprouts or hypocotyl part of the srpouts.

15. The method of claim 12, wherein prior to the pulverization, the method further comprises:
soaking the bean sprout to an NaCl aqueous solution at a concentration from about 0.05 to about 0.15wt. %; and
heating the mixture of the bean sprout and the NaCl solution to a temperature of about 90 to about 100° C.

16. The method of claim 13, wherein the heating continues for about 1 to 4 minutes.

17. The method of claim 12, further comprising boiling the pulverized mixture for about 1 to 10 minutes.

18. The method of claim 12, further comprising adding a sweetener to the collected liquid at a concentration of 0.1 to 0.5 wt %.

19. The method of claim 12, wherein the sweetener is selected from the group consisting of glucose, sucrose, fructose, sugar and artificial sweeteners.

20. A nutritional drink comprising:
an extract of the bean sprouts produced by the method of claim 1; and
a diluent.

21. The nutritional drink of claim 20, wherein the extract is prepared by a method comprising:
providing the bean sprouts produced by the method of claim 1;
pulverizing the bean sprouts in water; and
filtering the pulverized mixture to collect liquid.

22. The nutritional drink of claim 20, wherein the bean sprouts pulverized in water are in the form of the whole sprouts, cytyledon part of the sprouts or hypocotyl part of the srpouts.
